(19) United States
(12) Patent Application Publication
(10) Pub. No.: US 2026/0361932 A1
(43) Pub. Date: Nov. 12, 2026

(54) HUB-AND-SPOKE ARCHITECTURE FOR DISTRIBUTED REQUEST FILTERING

(71) Applicant: PubMatic, Inc., Redwood City, CA (US)

(72) Inventors: Shirish ANAND, Livermore, CA (US); Sagar TAKAWANE, Sunnyvale, CA (US); Rohan BANKAR, Sunnyvale, CA (US); Mukesh JANGID, Sunnyvale, CA (US); Prashant DABHADE, Pune (IN)

(73) Assignee: PubMatic, Inc., Redwood City, CA (US)

(21) Appl. No.: 19/200,925

(22) Filed: May 7, 2025

(51) Int. Cl. H04N 21/222; G06Q 30/08; H04N 21/81

(52) U.S. Cl. CPC H04N 21/222; G06Q 30/08; H04N 21/812

(57) ABSTRACT

Systems and methods are disclosed for implementing a scalable hub-and-spoke architecture for distributed request filtering, such as in programmatic media environments. In some examples, publishers (spokes) deploy localized, on-premise filtering systems that intercept and evaluate commercial content requests before transmission. Each on-premise system communicates with a centralized hub operated by a Supply-Side Platform (SSP), which provides model updates, filtering criteria, and marketplace insights. This framework allows coordinated, real-time traffic optimization, allowing low-value requests to be filtered at the source while preserving high-value opportunities.

### TECHNICAL FIELD

The present disclosure relates generally to hub-and-spoke architectures, and more specifically to hub-and-spoke architectures for distributed requested filtering.

### DESCRIPTION OF RELATED ART

In distributed computing and networked systems, hub-and-spoke architectures are commonly used to facilitate communication, data routing, and centralized coordination across multiple endpoints. In such architectures, a central hub manages or synchronizes operations across multiple distributed nodes or spokes. While this model has been successfully applied to areas such as content distribution, cloud storage, and messaging frameworks, its application to real-time request filtering-particularly for large-scale, latency-sensitive environments-remains limited. Existing filtering systems are often either fully centralized, resulting in scalability constraints and single points of failure, or fully decentralized, which can lead to inconsistent policies, redundant processing, and fragmented data visibility. Hybrid approaches have been proposed, but typically lack tight coordination between the central intelligence and edge filtering logic. A general need remains for systems that allow distributed endpoints to perform localized filtering operations in alignment with globally updated models or rulesets provided by a central hub.

Current solutions to this problem are fragmented and suboptimal. Consequently, it is beneficial to provide enhanced mechanisms for hub-and-spoke based request filtering.

### OVERVIEW

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

One aspect of the present disclosure relates to a technique for receiving a traffic shaping model from a hub. The traffic shaping model received at a spoke is configured to enhance filtering of requests from the spoke to the hub. A request is received at a proxy service implemented at the spoke and a traffic shaping model is applied to the request at the proxy service. The traffic shaping model is trained using data aggregated by the hub. The request at the proxy service is filtered by using the traffic shaping model.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments.

FIG. 1 illustrates an example of a digital content monetization ecosystem.

FIG. 2 illustrates an example of a digital content monetization system having a content provider traffic shaping system.

FIG. 3 illustrates an example of an exchange diagram for an intelligent traffic shaping system.

FIG. 4 illustrates an example of a process flow diagram for a traffic shaping system.

FIG. 5 illustrates an example of a computer system.

### DESCRIPTION OF EXAMPLE EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, portions of the techniques of the present disclosure will be described in the context of generative AI. However, it should be noted that the techniques of the present disclosure apply to a wide variety of different computer systems. In the following description, numerous specific details are set forth in order to provide a thorough understanding of the present disclosure. Particular example embodiments of the present disclosure may be implemented without some or all of these specific details. In other instances, well-known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of connections, such as a bus, may reside between the processor and memory. Consequently, a connection does not necessarily mean a direct, unimpeded connection unless otherwise noted.

Hub-and-spoke architectures are used in distributed systems to manage communication and coordination between a centralized control node (the hub) and multiple distributed endpoints (the spokes). This architecture allows centralized oversight and intelligence while delegating certain operations to the edge, thereby improving scalability, responsiveness, and operational efficiency. By allowing spokes to perform localized tasks in alignment with centralized policies, hub-and-spoke systems reduce bottlenecks, facilitate dynamic updates, and support real-time adaptation across large, decentralized networks.

In the context of programmatic media, content publishers seeking to monetize their digital properties generate a massive volume of commercial content placement requests. These requests are transmitted to multiple Supply-Side Platforms (SSPs) to solicit real-time bids from demand-side entities. However, a large portion of these requests are low-value and fail to attract meaningful interest from buyers. Each request consumes compute, bandwidth, and energy-not only at the publisher level but across the entire supply chain-as it is processed by multiple downstream systems. This results in substantial resource waste and infrastructure inefficiency, particularly when identical or near-duplicate requests yield no actionable outcome.

While some publishers have implemented localized filtering tools or rely on third-party vendors to reduce outbound traffic, these solutions often operate in isolation from the SSPs that ultimately assess request value. This misalignment between upstream filtering and downstream decision logic creates inconsistencies, reduces filtering precision, and limits system-wide optimization. A more coordinated, intelligent approach is needed to align local traffic shaping with the broader dynamics of the demand ecosystem.

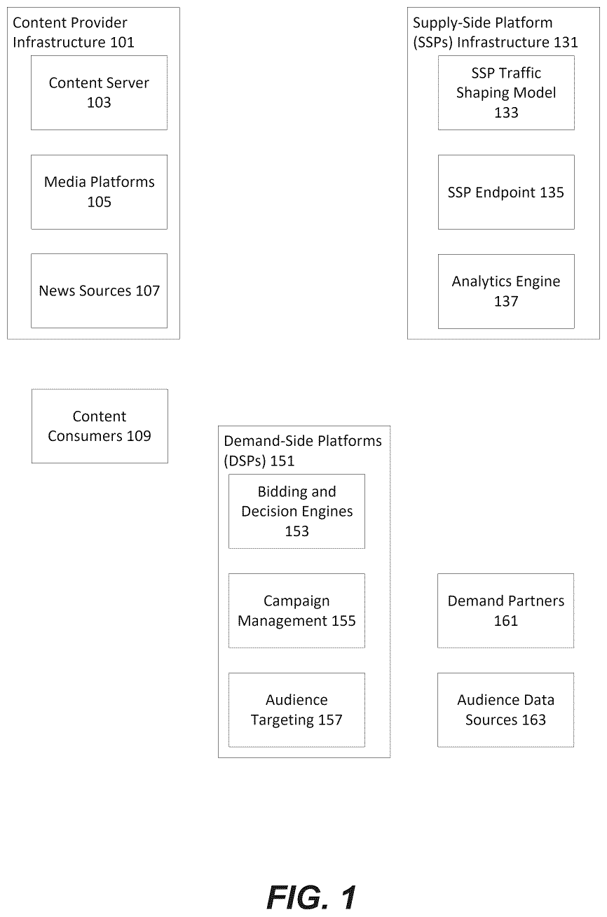

According to various embodiments, a distributed request filtering system is provided that implements a hub-and-spoke architecture for scalable, intelligent traffic shaping. In this framework, each publisher or content provider (spoke) deploys an on-premise proxy service that evaluates outgoing commercial content requests in real time using a machine learning model. These models are trained using marketplace-level data provided by the SSP (hub), including bid response histories, campaign performance, and buyer behavior trends. By delegating filtering to the edge while centralizing model updates and decision logic at the SSP hub, the system allows efficient request suppression at the source, reduces unnecessary downstream processing, and ensures consistent decision-making across the network. This architecture improves resource utilization, maintains ultra-low latency for high-value requests, and allows SSPs to dynamically manage incoming traffic volume from multiple publishers through coordinated model distribution. FIG. 1 illustrates an example of a digital content monetization ecosystem. In a typical digital content monetization ecosystem, multiple entities interact to facilitate the delivery of commercial content to users. According to various embodiments, this ecosystem operates through a series of interconnected systems and platforms that allow the buying and selling of digital advertising inventory.

According to various embodiments, a spoke such as content provider infrastructure 101 represent the digital properties that generate content for consumption by users. In particular embodiments, this infrastructure hosts various types of content platforms including content servers 103, media platforms 105, and news sources 107. Content servers 103 such as web servers provide web-based content accessible through browsers on various devices. According to various embodiments, these websites include areas on their pages that can display commercial content.

In particular embodiments, media platforms 105 offer specialized content delivery mechanisms such as streaming video, audio content, or interactive media experiences. In particular examples, these platforms typically integrate commercial content opportunities within their content flow, such as pre-roll, mid-roll, or post-roll placements. News sources 107 deliver informational content and current events coverage, that allow for commercial content alongside articles, videos, and other news-related content. According to particular embodiments, these sources often have high-value advertising inventory due to their engaged audiences.

According to various embodiments, when a content consumer 109 accesses content from any of these sources, the content provider servers 101 initiate a process to populate available commercial content spaces with relevant promotional materials.

In some examples, the SSP infrastructure 131 serves as an intermediary system that helps content providers manage and optimize their commercial inventory. According to various embodiments, the SSP represents the supply side of the ecosystem and works to maximize revenue for content providers. A hub such as SSP infrastructure 131 may include various SSP endpoints that each may have various types of functionality. An SSP endpoint may include traffic shaping model 133 that analyzes incoming requests for commercial content placement to determine their potential value. In particular embodiments, this component evaluates various parameters of each request, including user attributes, contextual information, and historical performance data, to predict the likelihood of generating revenue. According to particular examples, the traffic shaping model 133 may decide to process or reject requests based on these predictions, conserving some computational resources by filtering out low-value opportunities.

According to various embodiments, SSP endpoint 135 receives and processes bids from multiple demand sources for each commercial content opportunity. SSP endpoint 135 may include a bid collection and aggregation engine In various embodiments, this component conducts real-time auctions, evaluates bids against business rules and floor prices, and determines the winning bid for each placement opportunity. According to particular embodiments, the engine is responsible for maximizing the value of each impression while adhering to the content provider's policies. In conventional implementations, unfiltered commercial content or advertisement requests are received from content provider infrastructure and processed by the SSP endpoint 135. Analytics engine 137 collects, processes, and presents data regarding commercial content performance and statistical data. In particular examples, this component generates insights about inventory value, buyer behavior, user engagement, and revenue patterns. According to various embodiments, content providers and SSP operators use these insights to optimize their monetization strategies and improve future performance.

According to various embodiments, a digital content monetization system may also include Demand-Side Platforms 151. DSPs 151 represent the buying side of the ecosystem, providing technologies that allow demand partners 161 to efficiently purchase commercial content placements across multiple content providers.

Bidding and decision engines 153 evaluate each impression opportunity against campaign parameters and determine appropriate bid amounts in real-time. According to particular embodiments, these engines employ algorithms that consider factors such as audience match, context relevance, historical performance, and campaign goals to calculate the potential value of each impression to the demand partner.

Campaign management systems 155 allow demand partners to define, organize, and control their promotional campaigns. In various embodiments, these systems allow for setting budgets, timing parameters, targeting criteria, creative assets, and performance goals. According to particular examples, campaign management provides interfaces for demand partners to deploy, monitor, and adjust their commercial content distribution strategies. Audience targeting capabilities 157 allow demand partners to specify the characteristics of users they wish to reach with their commercial content. In various embodiments, these capabilities leverage various data signals, including demographic information, behavioral patterns, interests, and intent indicators to match promotional content with relevant audiences.

According to various embodiments, demand partners 161 represent the entities seeking to distribute commercial content to relevant audiences. According to various embodiments, these may include brands, retailers, service providers, and other commercial entities looking to promote their offerings. In particular examples, demand partners define campaign objectives, provide creative assets, establish budgets, and set performance expectations for their promotional activities. Audience data sources 163 provide information about content consumers 109 that enhances targeting capabilities within the ecosystem. In particular embodiments, these sources may include first-party data collected by content providers 101 or demand partners, as well as third-party data from specialized providers. The data can help categorize users according to various attributes, allowing more precise matching between commercial content and receptive audiences.

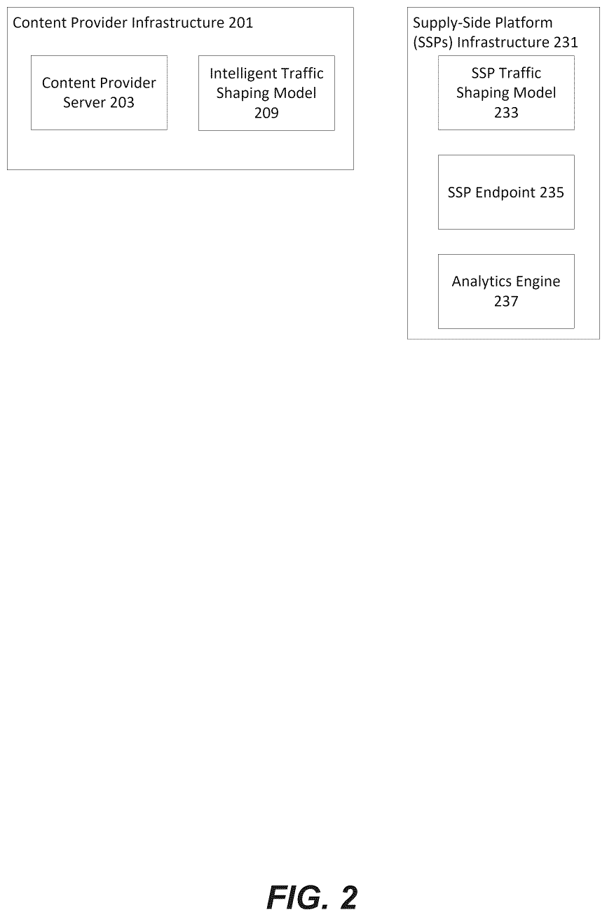

FIG. 2 illustrates one example of content provider or publisher infrastructure having a content provider infrastructure traffic shaping model or throttling mechanism. According to various embodiments, the content provider infrastructure 201 includes the systems and services operated by entities that publish digital content for consumption by users. In particular embodiments, this infrastructure 201 includes various components that work to deliver content and manage commercial content opportunities.

In particular embodiments, content provider server 203 hosts and delivers digital content to content consumers. In various embodiments, the content provider server 203 manages content delivery, user sessions, and the integration of commercial content within the user experience. According to particular embodiments, this server typically forwards all commercial content requests to SSP infrastructure without preliminary evaluation or filtering.

In various embodiments, the intelligent traffic shaping model 209 allows intelligent preliminary filtering of commercial content requests at their source. According to particular examples, this model is implemented as a reverse proxy service deployed within the content provider infrastructure 201, intercepting commercial content requests before they are transmitted to external systems.

According to various embodiments, the intelligent traffic shaping model 209 employs sophisticated machine learning algorithms to predict the likelihood of a commercial content request resulting in a successful placement. In particular embodiments, the model evaluates numerous parameters associated with each request, including contextual signals, user attributes, and historical performance patterns, to make this prediction. According to various embodiments, an intelligent traffic shaping model 209 trained using data available to SSP infrastructure 231 offers significant benefits over one trained exclusively with content provider data. In particular examples, the SSP possesses comprehensive marketplace visibility across multiple demand partners, including bidding patterns, campaign activities, and temporal market insights that individual content providers cannot access. According to particular embodiments, this broader perspective allows more accurate prediction of which requests will yield successful placements.

In various embodiments, training the content provider model with SSP data ensures enhanced alignment with downstream decision-making criteria, creating a harmonized approach to efficiency across the entire supply chain. According to particular examples, this alignment eliminates the inefficiencies that would arise from contradictory filtering decisions at different points in the request processing workflow, as the content provider model effectively learns to make the same determinations that the SSP traffic shaping model 233 would make. In particular embodiments, this synchronized training approach allows continuous refinement of both models in response to evolving marketplace conditions, allowing for consistent application of filtering criteria and maximizing resource conservation throughout the ecosystem.

In particular examples, the intelligent traffic shaping model 209 decides to forward the request to the SSP infrastructure 231 or to filter the request and respond with a default message to the content provider server without transmission. In various embodiments, this decision process occurs with ultra-low latency to maintain the responsiveness of the content delivery experience. When a system has a traffic shaping model deployed at potentially thousands of nodes (publishers) that are sending traffic to the SSP, it creates a highly efficient “hub-and-spoke” network-where the SSP is the hub and the nodes (publishers) represent the spokes, each of which has traffic shaping or throttling deployed at content provider infrastructure.

According to various embodiments, this creates a distributed traffic shaping system across thousands of publishers and in this system any inefficient traffic can be throttled at the source, thereby reducing wasted network and computational resources downstream. This system also allows the SSP to control centrally how much traffic they want to receive from their publishers based on their own capacity constraints. It gives unprecedented control over the incoming traffic that the SSPs receive from their publishers.

According to various embodiments, a distinctive characteristic of the intelligent traffic shaping model 209 is its training methodology. In particular embodiments, the model is trained using data at the SSP infrastructure 231, ensuring that its filtering decisions align with the evaluation criteria used by downstream systems, to accurately predict which requests would be deemed low-value by the SSP infrastructure. The SSP infrastructure has access to data from multiple content providers, from Demand-Side Platforms, and has a larger picture overview of network traffic and demand. It should be noted that SSP infrastructure 231 may still include an SSP traffic shaping model 233 for circumstances where content provider servers lack their own intelligent traffic shaping models 209. According to various embodiments, the training data may include historical request parameters, outcome data (successful vs. unsuccessful placements), and bidding patterns observed within the SSP infrastructure 231.

According to particular embodiments, the intelligent traffic shaping model 209 may also incorporate data from other content provider servers within the ecosystem. In various embodiments, this cross-provider data sharing enhances the model's predictive capabilities by expanding its training dataset beyond the experience of a single content provider.

In particular embodiments, the SSP infrastructure 231 encompasses the systems operated by the Supply-Side Platform that traditionally receives and processes all commercial content requests from content providers. In particular embodiments, this infrastructure includes multiple components that manage different aspects of the commercial content request processing workflow.

According to various embodiments, when a content provider implements the intelligent traffic shaping model 209, the SSP traffic shaping model 233 can be partially or completely bypassed. In particular embodiments, this bypass configuration acknowledges that preliminary filtering has already occurred upstream, eliminating the need for redundant evaluation within the SSP infrastructure 231.

According to particular examples, bypassing the SSP traffic shaping model 233 for pre-filtered traffic creates additional efficiency gains within the SSP infrastructure 231, as computational resources previously allocated to evaluating all incoming requests can be reallocated to other functions.

In various embodiments, the SSP endpoint 235 receives commercial content requests from content provider infrastructure 201 and coordinates their processing within the SSP infrastructure 231. According to particular examples, this endpoint 235 may implement specialized routing logic for requests originating from content providers with deployed traffic shaping models versus those without such models.

According to various embodiments, the SSP endpoint 235 is responsible for forwarding qualified requests to demand partners and collecting bid responses. In particular embodiments, it orchestrates the auction process and determines winning bids for each commercial content opportunity. An analytics and reporting module 237 collects and processes data regarding commercial content request outcomes, bid patterns, and performance metrics. In particular examples, this module generates insights that inform business decisions and system optimizations throughout the ecosystem.

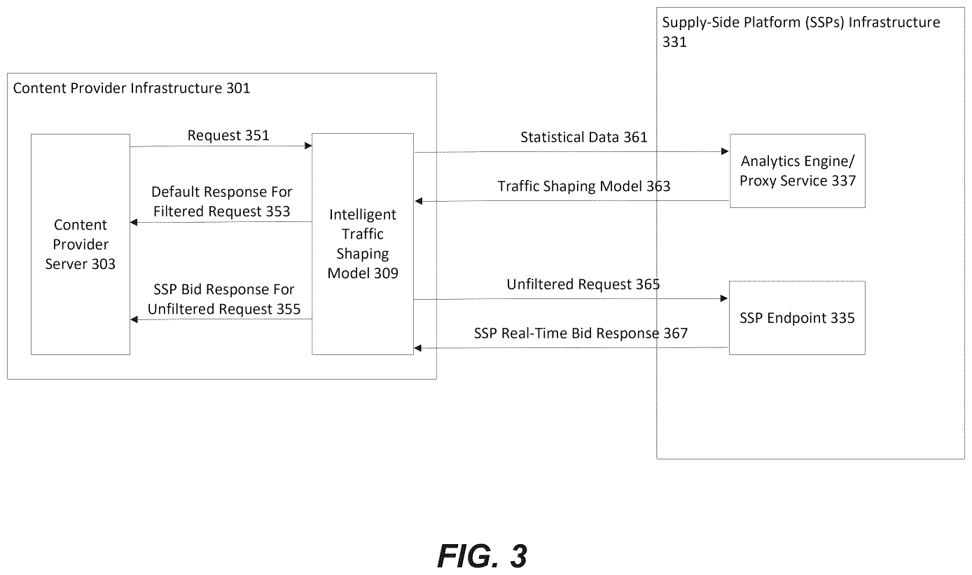

FIG. 3 illustrates one example of a transaction diagram for throttled commercial content requests. According to various embodiments, the content provider infrastructure 301 includes multiple components that work together to manage commercial content opportunities. According to particular examples, the content provider server 303 generates commercial content requests 351 when content consumers access digital properties and commercial content opportunities are identified. In particular embodiments, instead of sending these requests directly to external systems, the server forwards them to the intelligent traffic shaping model 309 for preliminary evaluation.

According to various embodiments, the intelligent traffic shaping model 309 represents a sophisticated machine learning-based system deployed within the content provider's own infrastructure. In particular examples, this model evaluates each commercial content request 351 to determine its revenue potential and likelihood of successful placement. According to particular embodiments, upon receiving a commercial content request 351, the intelligent traffic shaping model 309 generates a default response 353 for filtered requests and returns it directly to the content provider server 303. According to particular examples, this filtering occurs entirely within the content provider infrastructure 301, preventing unnecessary network transmission and downstream processing.

In various embodiments, for requests that are unfiltered based on criteria such as likelihood of successful placement, the intelligent traffic shaping model 309 forwards the unfiltered request 365 to the SSP endpoint 335 within the SSP infrastructure 331. According to various embodiments, the SSP infrastructure 331 contains multiple components that process incoming requests and provide feedback to improve system performance. In particular examples, the SSP endpoint 335 serves as the interface that receives unfiltered requests 365 from content providers and manages the commercial content acquisition process.

According to particular embodiments, upon receiving an unfiltered request 365, the SSP endpoint 335 processes it through the appropriate workflows to solicit bids from demand partners. In various embodiments, once a winning bid is determined, the SSP endpoint 335 generates an SSP real-time bid response 367 and returns it to the intelligent traffic shaping model 309 within the content provider infrastructure 301.

In particular examples, the SSP infrastructure 331 may optionally implement additional traffic shaping logic to further filter requests that pass through the content provider's intelligent traffic shaping model 309. According to various embodiments, this secondary filtering can provide an additional layer of efficiency, though it becomes less necessary as the content provider's model becomes more accurately aligned with downstream decision criteria.

According to various embodiments, the analytics engine/proxy service 337 within the SSP infrastructure 331 plays a role in the continuous improvement of the system. In particular examples, the intelligent traffic shaping model 309 regularly transmits statistical data 361 to this service, providing information about filtering decisions, request volumes, and outcome patterns. According to particular embodiments, the analytics engine/proxy service 337 processes this information alongside other data available within the SSP infrastructure 331 to refine its understanding of value-predictive factors. In various embodiments, this refined understanding is periodically encapsulated in updated traffic shaping models 363, which are provided back to the content provider infrastructure 301.

According to particular examples, these model updates allow for intelligent traffic shaping models that remain synchronized with evolving marketplace conditions and downstream decision criteria. In various embodiments, this synchronization maintains the accuracy and effectiveness of the filtering decisions over time.

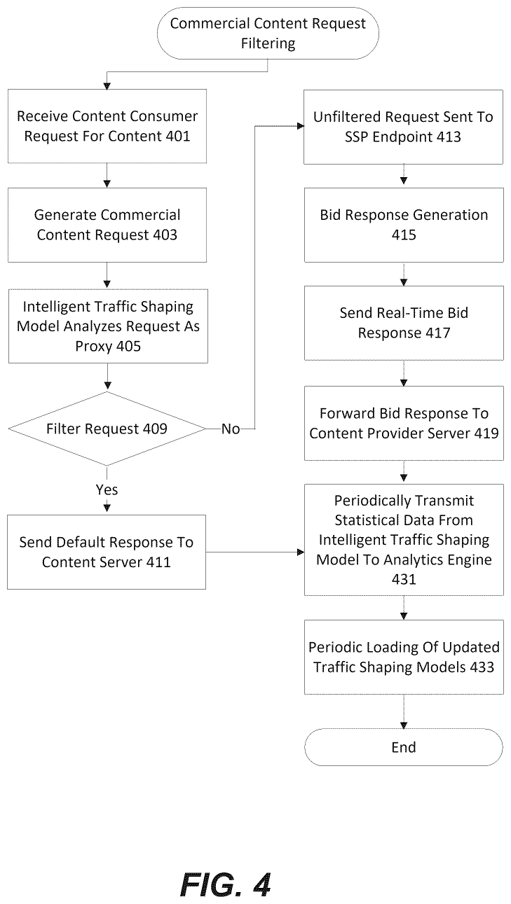

FIG. 4 is a process flow diagram illustrating an example of a commercial content request process. According to various embodiments, a user or content consumer request for content is received at content provider infrastructure at 401. In particular examples, the content provider server generates a commercial content request at 403. According to various embodiments, the intelligent traffic shaping model analyzes the request as a proxy at 405 before any transmission to SSP infrastructure.

According to particular embodiments, the intelligent traffic shaping model analyzes the request to evaluate whether to filter at 409. If a determination is made to filter at 409, the model generates and sends a default response at 411 to the content provider server, effectively blocking the request from reaching the SSP infrastructure.

According to various embodiments, for unthrottled requests, the intelligent traffic shaping model forwards the unfiltered request to the SSP endpoint at 413 for processing. In particular examples, bid response generation occurs as the SSP endpoint processes the request 415 and sends back a real-time bid response 417 to the content provider infrastructure. According to particular embodiments, the intelligent traffic shaping model then forwards this bid response to the content provider server at 419.

In various embodiments, additional operations include regular transmission of statistical data from the intelligent traffic shaping model to the analytics engine/proxy service at 431, and periodic loading of updated traffic shaping models to optimize the filtering decisions at 433. According to particular examples, this system provides significant efficiency improvements in traffic shaping and traffic management, allowing improved request handling and lowering infrastructure as well as operating costs.

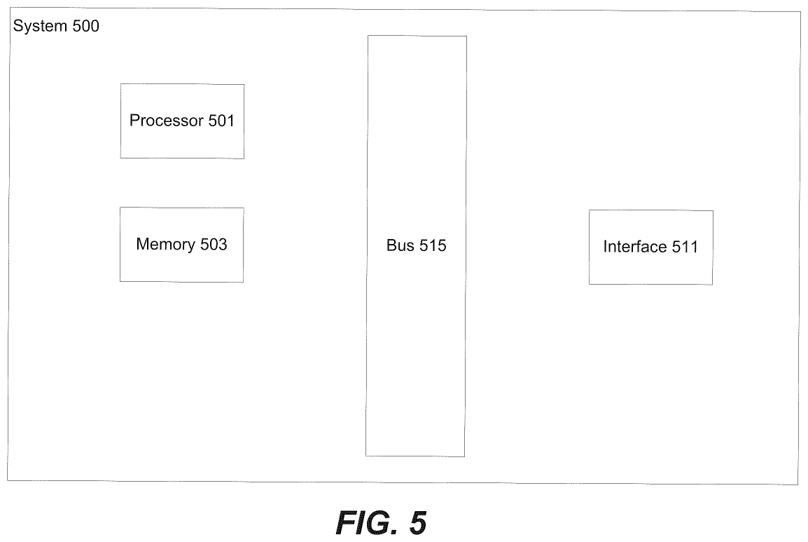

The examples described above present various features that utilize a computer system to implement traffic shaping functionality. FIG. 5 illustrates one example of a computer system, in accordance with embodiments of the present disclosure. According to particular embodiments, a system 500 suitable for implementing aspects of the traffic shaping infrastructure includes a processor 501, a memory 503, an interface 511, and a bus 515 (e.g., a PCI bus or other interconnection fabric). When acting under the control of appropriate software or firmware, the processor 501 is responsible for executing traffic filtering logic, proxy services, analytics engines, and containerized services such as machine learning-based traffic shaping models. Various specially configured devices can also be used in place of processor 501 or in addition to processor 501. The interface 511 is typically configured to send and receive data packets or data segments over a network, including real-time content request traffic and model updates.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces, and the like. Generally, these interfaces may include ports appropriate for communication with the appropriate media. In some cases, they may also include an independent processor and, in some instances, volatile RAM. The independent processors may control communications-intensive tasks such as request forwarding, traffic filtering, bid processing, or model synchronization across a distributed infrastructure.

According to various embodiments, the system 500 is a computer system configured to implement traffic shaping infrastructure as described herein. In some implementations, one or more of the computer components may be virtualized. For example, a physical server may be configured in a localized or cloud environment, or as an edge compute node deployed at a content provider. The physical server may implement one or more virtual server environments, such as containerized microservices performing request evaluation and filtering. Although a particular computer system is described, it should be recognized that a variety of alternative configurations are possible. For example, the modules may be implemented on another device connected to the computer system or distributed across multiple nodes in a network.

In the foregoing specification, the present disclosure has been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure.

1. A method, comprising:
receiving a traffic shaping model from a hub, wherein the traffic shaping model received at a spoke is configured to enhance filtering of requests from the spoke to the hub;
receiving a request at a proxy service implemented at the spoke;
applying the traffic shaping model to the request at the proxy service, wherein the traffic shaping model is trained using data aggregated by the hub; and
filtering a request at the proxy service by using the traffic shaping model.

2. The method of claim 1, wherein the hub is Supply Side Platform (SSP) infrastructure.

3. The method of claim 2, wherein the spoke is content provider infrastructure.

4. The method of claim 3, wherein the request is a commercial content request.

5. The method of claim 4, wherein real-time statistical data is sent to the SSP infrastructure.

6. The method of claim 4, wherein the commercial content request is filtered to reduce transmissions of commercial content request to the SSP infrastructure.

7. The method of claim 6, wherein a default response is provided for a content provider page when the commercial content request is filtered.

8. The method of claim 7, wherein the commercial content request is unfiltered and transmitted to an SSP endpoint in the SSP infrastructure.

9. The method of claim 8, wherein the SSP endpoint responds with an SSP real-time bid response.

10. The method of claim 9, wherein a content provider server in the content provider infrastructure receives the SSP bid response for the unfiltered commercial content request.

11. The method of claim 10, wherein the SSP endpoint includes a bids and aggregation engine.

12. The method of claim 11, wherein the traffic shaping model is generated using statistics from SSP infrastructure and a plurality of content provider servers.

13. The method of claim 12, wherein the traffic shaping model is generated using real-time statistics from SSP infrastructure and a plurality of content provider servers.

14. The method of claim 13, wherein the traffic shaping model sent to the content provider is trained using the same dataset used to train an SSP traffic shaping model used by SSP infrastructure to filter commercial content requests.

15. A system, comprising:
means for receiving a traffic shaping model from a hub, wherein the traffic shaping model received at a spoke is configured to enhance filtering of requests from the spoke to the hub;
means for receiving a request at a proxy service implemented at the spoke;
means for applying the traffic shaping model to the request at the proxy service, wherein the traffic shaping model is trained using data aggregated by the hub; and
means for filtering a request at the proxy service by using the traffic shaping model.

16. The system of claim 15, wherein the hub is Supply Side Platform (SSP) infrastructure.

17. The system of claim 16, wherein the spoke is content provider infrastructure.

18. The system of claim 17, wherein the request is a commercial content request.

19. The system of claim 18, wherein real-time statistical data is sent to the SSP infrastructure.

20. A non-transitory computer readable medium comprising:
computer code for receiving a traffic shaping model from a hub, wherein the traffic shaping model received at a spoke is configured to enhance filtering of requests from the spoke to the hub;
computer code for receiving a request at a proxy service implemented at the spoke;
computer code for applying the traffic shaping model to the request at the proxy service, wherein the traffic shaping model is trained using data aggregated by the hub; and
computer code for filtering a request at the proxy service by using the traffic shaping model.
